(19) United States
(12) Patent Application Publication
(10) Pub. No.: US 2014/0279369 A1
(43) Pub. Date: Sep. 18, 2014

(54) METHODS, SYSTEMS, AND COMPUTER-READABLE MEDIA FOR AUTOMATING TRADING AND REVERSING OF FINANCIAL TRADES

(71) Applicant: FINANCIAL TRACKING TECHNOLOGIES, LLC, Riverside, CT (US)

(72) Inventor: Walter Anthony Turner, Riverside, CT (US)

(73) Assignee: FINANCIAL TRACKING TECHNOLOGIES, LLC, Riverside, CT (US)

(21) Appl. No.: 14/215,715

(22) Filed: Mar. 17, 2014

Related U.S. Application Data
(60) Provisional application No. 61/799,453, filed on Mar. 15, 2013.

(51) Int. Cl. G06Q 40/04

(52) U.S. Cl. CPC G06Q 40/04; G06Q 40/06
USPC 705/37

(57) ABSTRACT

According to one or more disclosed embodiments, a plurality of data inputs are received from a plurality of information sources regarding one or more investment portfolios. Also, a proposed change to at least one of the investment portfolios is received. Then, it is determined whether the proposed change would cause a deviation from one or more guidelines. When the proposed change causes a deviation from the one or more guidelines, the proposed change is rejected. Otherwise, one or more instructions for executing the proposed change are transmitted.

### RELATED APPLICATIONS

This application claims the benefit of and priority to U.S. Provisional Patent Application No. 61/799,453, filed Mar. 15, 2013, the contents of which are incorporated herein by reference.

### TECHNICAL FIELD

The present disclosure relates generally to financial services, and, more particularly, to securities trading.

### BACKGROUND

Financial services companies, investors and their suppliers commonly use a process that is manually initiated to periodically analyze and monitor characteristics of portfolios on a post-performance, ad hoc basis with primarily arbitrary outcomes. In addition, measuring consists primarily of investment performance and risk calculations while additional information, vital to assessing trends in portfolio additions and deletions and their impact on the portfolio, are not considered. Portfolio analyses are conducted and reviewed on a random basis, manually initiated, generally monthly or quarterly, well after the fact and not while the portfolio is being built and managed.

Given this, investment managers, be they self-directed, outsourced or provided internally by a company, basically “work in the dark” with investors not being aware of errors and mistakes until long after the fact and too late to take action. Further, continuous awareness and analysis of impact of fluctuations in world financial markets are not enjoyed by practitioners.

The current methodology presents still further problems for investors and investment managers alike. These problems include poor quality and reliability of results of portfolio and account analyses, lack of timely notification when investors get off track in meeting investment goals, when and how portfolio characteristics are changing against boundaries, when an investment manager deviates from their decision making model or investment philosophy, when to replace a manager or make changes in the portfolio composition before it is too late and minimize losses, and when and how to fine-tune the portfolio or investment process or both.

### SUMMARY

Accordingly, several objects and advantages of the system disclosed herein include automating portfolio analysis for continuous providing of consistent, high quality and reliable outcomes and results. The system can use more information more often and therefore output vital information to assess trends in the impact of portfolio additions and subtractions and price activities or fluctuations in world financial markets, or both, on the portfolio.

The system can provide for processing data automatically and continuously as the portfolio is being managed and displaying when an exception occurs in the portfolio, against predetermined boundaries. This can provide for immediate realization of mistakes or errors made by portfolio managers, allowing investors to be the first to know when they get off-track in meeting financial goals and objectives, or when a manager deviates from their decision-making process or investment philosophy.

The system can further provide for when and how to make changes in the portfolio and fine-tune the process before it is too late to minimize losses, thereby minimizing overall investment mistakes against predetermined boundaries.

Other objects and advantages include providing for more efficient and effective economical business and operating models by those that build, maintain and monitor portfolios or retain or replace third party managers, or any combination; benefiting a very large market consisting of investors worldwide; satisfying a tremendous psychological and economic need of all investors to be in the know immediately when their portfolio falls outside of predetermined; providing for labor, time and cost savings of the users; providing for a more convenient and easier to use system for portfolio and continuous scanning and displaying; and providing for automation of a manual process.

Additional objects and advantages of the system include the ability to provide for acceleration of process to continuous; to provide for reliability, precision, attentiveness and thoroughness in the investment management process; to provide for minimization of errors in investment management; to provide for compatibility with existing data sources and analytical tools; to provide for no inertia to be overcome for use; to provide for ease of promotion and grasp of benefit; to provide for use in an existing market benefiting mankind; to provide an enhancement to the trust between investors and portfolio managers; to provide for the acceleration of the rebalancing decision; and to provide for acceleration of the reallocation decision.

Still, further objects and advantages include the ability to provide for acceleration of short fall risk (ahead or behind in goals); to provide for leveraging good investment decisions if within boundaries; to provide for relief of the arduous and daunting task of monitoring and analyzing investment portfolios; to provide for more cost effective distribution for investment managers; to provide for ongoing validity of the composition and structure of a client's total portfolio; to provide for more and more timely and high quality communications between investors and managers; to provide for determination if investment policy is realistic against actual performance over the long term; to provide for objective, consistently applied approach to manager and evaluation; to provide for tracking error minimization; to provide for better tax efficiency; to provide for motivation to managers to think profoundly about portfolio return on an investor basis; to provide for higher probability of achieving desired returns, goals and objectives; to provide for immediate awareness of changes in decision making process and investment philosophy.

Finally, still further objects and advantages of the disclosed embodiments will become apparent from a consideration of the drawings and ensuing description.

### BRIEF DESCRIPTION OF DRAWINGS

The foregoing and other objects, features, aspects and advantages of the embodiments disclosed herein will become more apparent from the following detailed description when taken in conjunction with the following accompanying drawings.

FIGS. 1A to 1D show various exemplary components of the disclosed system.

FIG. 2 shows an exemplary revolving cycle of data and information flow.

FIGS. 3A and 3B show an exemplary flowchart of the process for inputting, identifying, counting, and displaying exceptions to predetermined data boundaries (i.e. the exceptions process).

FIG. 4 shows an exemplary system for investment portfolios that is manual.

FIG. 5 shows an exemplary system for investment portfolios that is manual and includes an interface.

FIG. 6 shows an exemplary system for investment portfolios that is manual and includes an interface and World Wide Web.

FIG. 7 shows an exemplary system for investment portfolios that is manual and includes the World Wide Web.

FIG. 8 shows an exemplary real-time continuous system which may be applied to any data input.

FIG. 9 shows an exemplary real-time continuous system which may be applied to any data input and includes an interface.

FIG. 10 shows an exemplary real-time continuous system which may be applied to any data input and includes the World Wide Web.

FIG. 11 shows an exemplary real-time continuous system which may be applied to any data input and includes an interface and World Wide Web.

FIG. 12 shows an exemplary real-time continuous system which is designed for investment portfolios and includes an interface.

FIG. 13 shows an exemplary system for automated clearance and processing of trades.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### LIST OF REFERENCE NUMERALS

14 continuous data inputs
16 interface
18 Central Processing Unit
20 data disk
22 pricing and security attribute inputs
24 process that controls and directs the apparatus for processing
26 exceptions reporting via the World Wide Web
28 process to access data on data disk
30 World Wide Web
32 process for computerized apparatus to store process results
34 report writer
36 device to continuously display exceptions results
38 World Wide Web application server
40 security firewall for the website
42 conventional portfolio accounting process
44 reporting process
46 conventional performance attribution process
48 conventional risk analysis process
50 continuous scanning for exceptions and displaying exceptions process
52 batch import process
1300 system for automated clearance and processing of trades
1302 compliance computer
1304 external data source
1306 internal data source
1308 trading platform

### DETAILED DESCRIPTION OF THE DRAWINGS

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that a number of the below methods are executed by at least one controller. The term “controller” refers to a hardware device that includes a memory and a processor. The memory is configured to store program instructions and the processor is specifically configured to execute said program instructions to perform one or more processes which are described further below.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

A preferred embodiment is illustrated in FIGS. 1A-1D, 3A and 3B. The system has continuous data inputs 14 from multiple sources. These sources include investment managers, custodians of securities, transfer agents, real time financial markets data, and vendors of data, or any combination. These inputs consist of desired data characteristics of the portfolio, boundaries for each of the desired data characteristics of the portfolio, security data, portfolio data, trade data, position data, quantity data, account data, all validated and reconciled, and are connected to an apparatus for continuous processing via interface process 16 via a transmission of data in a batch import process 52.

Interface 16 provides automated data retrieval, validation, and correct and timely import format into conventional portfolio accounting process 42. Interface 16 consists of code logic, test logic, inputs data repository, processing logic, and data destination fields. A pricing and financial markets and securities data input 22 is used to continuously update prices and data to the system and is connected to transmit data. The portfolio accounting process 42 continuously processes additions and deletions and price changes, and calculates investment performance data.

Multiple dedicated central processing units 18 with enough data disk 20 and enough memory and processing capacity and capability are used to enable the continuous process. These processes include a process for controlling and directing the units for processing 24, a method to access data 28 on disk 20, and a continuous reporting process 44 which configures the data output for reporting purposes. Further, additional processes include a conventional performance attribution process 46 which continuously processes data and calculates the sources of performance from asset allocation, security selection, market timing, and interaction among these and enabled by unit 18, a conventional risk analysis process 48 for continuously processing data and calculating risk and enabled by unit 18, and a “rules” or exceptions process 50 for processing and scanning characteristics of the portfolio, and displaying exceptions to predetermined data boundaries and enabled by unit 18.

A storing process 32 is used for units 18 to store this output. This output is received by the data disk 20 and displayed by device for display 36. Data 26 is the resulting exceptions to boundaries data. A World Wide Web or Internet is 30. A report writer 34 is used to translate accounting, performance attribution, risk, and exception data from text file or table format to HTML format. Also needed is a World Wide Web application server 38 and World Wide Web security firewall 40.

FIG. 2 illustrates the establishment and revolving cycle of data flow used for initial data input and resulting data output.

FIGS. 3A and 3B illustrate the process 50 flowchart for continuously processing, scanning, identifying, and counting exceptions to boundaries and continuously displaying the exceptions to the boundaries. This processing method is continuous and enabled by units 18.

### Operation of the System of FIGS. 1A-1D, 3A and 3B

Predetermined desired characteristics of portfolios and their respective target ranges or boundaries, all based on portfolio guidelines, in the form of data for the investment securities, accounts, and portfolios are entered into the data boundaries process 50 (shown in FIGS. 3A and 3B). These boundaries are based on the objectives and goals of the investor. Specifically, they include, but are not limited, to:

a) Short term gains and losses;

b) Long term gains and losses;

c) Limitation on any special groupings;

d) Tracking error;

e) Risk;

f) Portfolio turnover;

g) Investment philosophy of the investment manager or investor if self-directed (characteristics may include but not be limited to market cap, growth and profitability measures, valuation ratios, economic sector weightings, earnings and price volatility statistics);

h) Decision making model of the investment manager or investor if self-directed (characteristics may include but not be limited to market cap, growth and profitability measures, valuation ratios, economic sector weightings, earnings and price volatility statistics, dividend yield, projections, revenues, roe, etc.);

i) Cash positions;

j) Performance attribution;

k) Changes in sources of return or loss;

l) Number of exceptions allowed by desired characteristic and overall;

m) Tracking error versus comparable capital market styles and sub-styles;

n) Age of each issue entering the portfolio (new issue or existing);

o) Number of positions;

p) U.S. or applicable state tax regulations or both;

q) Asset allocation; and

r) Portfolio return.

Next, the disclosed system receives data inputs 14 from the investor's investment managers, custodians of securities, transfer agents, and vendors of data, or any combination, via batch import process 52. These data inputs consist of real time financial markets data security data, portfolio data, trade data, position data, quantity data, account data, all validated and reconciled, upon confirmation, and are connected via interface 16.

Next, the interface 16 provides automated data retrieval, validation, and correct and timely import format into the conventional portfolio accounting process 42. The interface 16 consists of code logic, test logic, inputs data repository, processing logic, and data destination fields. The process 42 then processes data for additions and deletions in an account or portfolio or both, and therefore calculates investment performance.

Multiple dedicated central processing units 18 with enough memory and processing capacity and capability to enable the continuous performance of the process 42 are used. Conventional processes include a reporting process 44 which configures the data output for reporting purposes and a conventional performance attribution process 46 which calculates the sources of performance between asset allocation, security selection, market timing, and interaction among these. Further, a conventional risk analysis process 48 for calculating risk, and a “rules” or exceptions process 50 for continuously processing and scanning characteristics of the portfolio, counting and displaying exceptions to predetermined data boundaries, and counting and displaying exceptions to exceptions of exceptions of boundaries as shown in FIGS. 3A and 3B.

The process 42 is performed first using the output from interface 16 and a pricing and data inputs 22. Next, the risk analysis process 48 is performed using the output from the interface 16 and the process 42. Next, the process 46 is performed, using the output from the interface 16, process 48, and process 42. Next, a collective data from all these processes are received by the central processing units 18. Next, process 50 (as described in detail below) is performed by scanning the output from the interface 16, process 48, process 46, and process 42 to find and display exceptions to the predetermined boundaries.

FIGS. 3A and 3B Process 50 with Examples of Portfolio Characteristics

The process 50 illustrated in FIGS. 3A and 3B may be applied toward a number of portfolio characteristics, including the following exemplary portfolio characteristics. It should be noted that the following portfolio characteristics are described for demonstration purposes only, and the applicability of the disclosed embodiments (e.g., process 50) is not limited to the characteristics described below.

First, for portfolio performance versus a benchmark, conventional portfolio performance is calculated and compared to benchmark performance and displayed and stored; the difference in this amount, known as the tracking error, is displayed and stored. That is, the amount of portfolio performance that is above or below benchmark performance is the tracking error. If this comparison results in a tracking error outside the predetermined data boundaries, this is an exception and the process displays the result (the tracking error) and the result is stored.

Second, for changes in sectors or any special groupings, each addition or deletion or both to the portfolio is categorized by economic sector or special grouping(s), or both, and its market value obtained from a third party data inputs and added to the existing values of issues in the same sector or special grouping(s) for a total value and displayed and stored. This total value is then compared to the value before the additions or deletions or both. An exception is created if this value is not within the predetermined boundaries. If the total value is an exception, the program displays the result and the result is stored.

Third, for tax efficiency, as the gain or loss is calculated and determined to be a short term or long-term gain or loss per U.S. or applicable state tax regulations, or both, exceptions are created, reported and stored if the amount(s) previously described and calculated upon each additions or deletions or both do not equal the amount previous to the additions or deletions or both and outside the predetermined boundaries, and if so, are reported and stored.

Fourth, for top sources of return or loss, after each addition or deletion, or both, a performance attribution analysis is performed, including but not limited to allocation, selection, interaction, and active management for any special groupings or single issues, or both. Each of these areas is displayed and stored for the top five sources of return or losses for each (e.g., allocation, selection, etc.) and for the portfolio overall with respective data boundaries for each.

Fifth, for changes in sources of return or loss, after each addition or deletion, or both, a performance attribution analysis is performed, including but not limited to allocation, selection, interaction, and active management for any special groupings or single issues, or both. Each of these areas is displayed and stored for the top five sources of return or losses for each (e.g., allocation, selection, etc.). Next, the results in each desired characteristic are compared to the values, groupings, etc. after the previous analyses. Exceptions are created and reported and stored if the amount(s) previously described and calculated upon each additions or deletions, or both, do not equal the amount previous to the additions or deletions or both and outside the predetermined boundaries, and if so, are reported and stored.

Sixth, for risk, the risk may be conventionally calculated and compared to the risk prior to the additions or deletions, or both, and displayed and stored; the difference in this amount is displayed and stored. If the additions or deletions, or both, in the portfolio result in an increase or decrease in risk and fall outside the predetermined boundaries, the program displays and reports the exception, and the exception is stored.

Seventh, for changes in cash positions, a cash amount is compared to an amount previous to the additions or deletions, or both, and the change is displayed and stored. If the additions or deletions, or both, in the portfolio results in an amount not equal to the predetermined amount and fall within the predetermined boundaries, the program displays and reports the exception, and the exception is stored.

Eighth, for investment philosophy and constructing a decision-making model, each component of the investment philosophy or decision-making model, or both, is compared to the boundaries. An exception is created if the characteristics of the existing securities, additions or deletions, or both, are outside the predetermined boundaries, and the exception is reported, displayed and stored.

Ninth, for the number of exceptions created, the number of times an exception is created for each characteristic and the number of consecutive exceptions for each characteristic are counted. If either count is outside the predetermined boundaries, the exceptions and/or exception counts are displayed and stored.

Tenth, for portfolio turnover, the portfolio turnover annualized is conventionally calculated and compared to the amount of target turnover annualized previous to the additions or deletions, or both, and displayed and stored. If the additions or deletions, or both, result in an annualized amount not equal to the portfolio target amount annualized and fall outside the predetermined boundaries, an exception is displayed and stored.

Eleventh, for a number of positions in the portfolio, a count is made of the number of positions in the portfolio upon the additions or deletions, or both, and compared to the predetermined boundaries of positions and displayed and stored. If the number of positions does not equal the number prior to the additions or deletions, or both, and falls outside the predetermined boundaries, the program displays the exception and reports it by amount, and the exception is stored.

Twelfth, for portfolio return, the performance annualized is conventionally calculated and compared to the target range return and displayed and stored. If the performance of the portfolio does not equal the target performance, the program displays the exception and reports it by amount, and the exception is stored. This step also includes full portfolio attribution including allocation, selection, interaction, and active management.

Thirteenth, for asset allocation, after each addition or deletion, or both, asset allocation is refigured by a third party system, and the asset allocation is reported and stored. This total value and value for each asset class, style and substyle, and cash is then compared to the value(s) before the additions or deletions, or both. An exception is created if this value is not equal to the prior value before the additions or deletions, or both, and falls outside the predetermined boundaries. If the total value is an exception, the program displays the result and the result is stored.

Fourteenth, for new issues, after each addition or deletion, or both, an issue is identified as to whether or not it is a new or existing issue. If it is a new issue, the program signals this and stores the signal (e.g., results) and reports that a new issue has entered the portfolio. This signal is added to previous signals in order for a running count to be kept of the number of issues that entered the portfolio(s) when they were new.

This output, for any of the above-referenced portfolio characteristics, is received by and stored in the data warehouse 18. Data 26 is the resulting exceptions data to boundaries data and a result of process 50. The process 50, as shown in FIGS. 3A and 3B, refers to additions or subtractions, or both, in the portfolio and pricing data on financial markets and continuously identifies exceptions to the previously determined boundaries of data characteristics (e.g., “category”). The process 50 may be implemented as a computer program in the form of computer instructions (e.g., any suitable programming language, such as C++) by a computer. Further, the process 50 utilizes steps to store and display the results, as well as counting the number of consecutive exceptions to each boundary and stores the results. If the number of consecutive exceptions does not exceed a predetermined exceptions to exceptions threshold, then the process is repeated; if the number of consecutive exceptions does exceed the predetermined exceptions to exceptions threshold, then the results are displayed by data characteristics or category; if the number of consecutive exceptions to predetermined exceptions to exceptions boundaries exceeds the threshold count, the characteristics are displayed, the process then counts the number of characteristics falling outside the exceptions to exceptions, stores the results, and displays the number of characteristics in which exceptions to exceptions have been exceeded. The process is repeated unless financial markets close.

The report writer 34 is used to translate final accounting, performance attribution, risk, and exception data from text file or table format from the data disk 20 to HTML format. This HTML format data is then processed by the World Wide Web service application 38 and available through the World Wide Web firewall 40. The data can be obtained upon receiving a signal via the World Wide Web when an exception to predetermined boundaries occurs. The process, which consists of conventional portfolio accounting process 42, reporting process 44, conventional performance attribution process 46, conventional risk analysis process 48, and exceptions process 50, is performed continuously in real-time.

### FIGS. 4-12—Additional Embodiments

Additional embodiments of the disclosed system are shown in FIGS. 4-12. In FIG. 4, the system is illustratively designed for investment portfolios and is manual; in FIG. 5, the system is illustratively designed for investment portfolios, is manual and includes an interface; in FIG. 6, the system is illustratively designed for investment portfolios, is manual and includes an interface and the World Wide Web; in FIG. 7, the system is illustratively designed for investment portfolios, is manual and includes the World Wide Web; in FIG. 8, the system is illustratively performed continuously in real-time and can be applied to any data input; in FIG. 9, the system is illustratively performed continuously in real-time, can be applied to any data input and includes an interface; in FIG. 10, the system is illustratively performed continuously in real-time, can be applied to any data input and includes the World Wide Web; in FIG. 11, the system is illustratively performed continuously in real-time, can be applied to any data input and includes an interface and the World Wide Web; and FIG. 12, the system is illustratively performed continuously in real-time, can be applied to any data input, is designed for investment portfolios, and includes an interface.

Accordingly, one of skill in the art will see that the disclosed system provides for a highly reliable, thorough and attentive system in determining and displaying when portfolios fall outside predetermined boundaries, thus enabling investors to know when they get off-track in meeting investment goals, or when an investment manager deviates from the decision-making model, or both.

Additionally, the disclosed system provides for input, output, and use of information heretofore not continuously used in the process and allows the user to continuously assess trends in the impact of portfolio activities or fluctuations in prices in world financial markets, or both, on the investment portfolio. It also provides for immediate awareness of when and how to fine-tune the investment management process before it is too late to minimize losses.

Furthermore, the disclosed system has the additional advantages in that:

a) it provides for more economical business operating models;

b) it provides for worldwide application, benefiting mankind;

c) it provides for significant time savings;

d) it provides for a more convenient and easier way to monitor and scan investment portfolios and compatibility with existing data, analytical processes, and tools;

e) it provides for acceleration of the portfolio rebalance or reallocation decision, or both and awareness of shortfall risk;

f) it provides for a consistent approach to investment manager evaluation and selection and replacement;

g) it provides for greater tax efficiency.

### Automated Clearance and Processing of Trades

Referring now to FIG. 13, a system 1300 for automated clearance and processing of trades is provided. Such a system can be used both for internal trading (e.g., trading on behalf of an organization or an organization's clients) or external trading (e.g., trading relating to individual accounts of an organization's officers or employees). Both types of trading can raise compliance issues if not carefully monitored by the organization. However, as with all financial transactions, delays in compliance review can result in lost opportunities.

The system 1300 includes one or more compliance computers adapted and configured to:

a) receive a plurality of data inputs from a plurality of information sources regarding one or more investment portfolios;

b) receive a proposed change to at least one of the investment portfolios;

c) determine whether the proposed change would cause a deviation from one or more guidelines; and

d) if the proposed change would cause a deviation from the one or more guidelines, reject the proposed change;

e) otherwise, transmit one or more instructions for executing the proposed change.

In order to determine if the proposed change would cause a deviation from one or more guidelines, the compliance computers 1302 can interact with one or more systems. For example, the compliance computer 1302 can interact with one or more external data sources 1304, one or more internal data sources 1306, and trading platforms 1308 for one or more broker-dealers. For example, the compliance computer 1302 can obtain information such as stock price and market capitalization from an external data source 1304 such as BLOOMBERG. The compliance computer 1302 can also interact with one or more internal data sources 1306 that can include information that is manually identified. These data sources 1304, 1306 can provide continuous or near-continuous data streams or can batch updates.

Organizations can implement policies that require that all trades, whether internal or external, be processed through the compliance computer 1302 before execution. In some embodiments, the organization will host an interface for submission of proposed trades. In other embodiments, the broker-dealer or other third party will provide an interface, which could be their usual interface or a specially-made user interface. Upon submission, the proposed trade will be sent to the compliance computer 1302 for analysis.

The compliance computer 1302 determines whether the proposed trade would cause a deviation from one or more guidelines. As discussed herein, the one or more guidelines can specify that a portfolio cannot contain more than a certain amount of a particular security, securities from a particular industry, company size, country, or region. In other situations, the organization can have a restricted securities list of companies that the organization or the organization's officers and employees cannot trade in.

If the proposed change would cause a deviation from the one or more guidelines, the compliance computer 1302 rejects the proposed trade. Otherwise, the compliance computer automatically forwards the proposed trade to the broker-dealer or other party for execution.

### Automated Reversing of Trades

Despite best compliance efforts, an organization may discover that one or more trades were executed that violate one or more guidelines. Another aspect of the invention provides a system for automated reversal of trades in such a situation.

When a trade is made using this aspect of this invention, the instructions to execute the trade are stored. For example, instructions to purchase 1,000 shares of ABC Corp. can be stored in memory or disc. When instructions to reverse the trade are received, the system generates and transmits one or more additional instructions to reverse the trade. Depending on the situation, these instructions can take various forms. If the trade is pending, instructions to cancel or partially cancel the trade can be sent to a broker-dealer. For example, if guidelines would permit the portfolio to own 750 shares of ABC Corp., instructions to cancel or modify a pending trade so as to only purchase 750 shares can be transmitted. If the trade is completed, opposite instructions can be generated. For example, an order to sell 1,000 shares of ABC Corp. can be transmitted to the broker-dealer.

### EQUIVALENTS

While the above description contains many specificities, these should not be construed as limitations on the scope of the invention, but rather as an exemplification of one preferred embodiment thereof. Many other variations are possible, including, for example, a system for portfolios, the system for portfolios and an interface, the system for portfolios and an interface and World Wide Web for distributing results, the system for portfolios and World Wide Web for distributing results, system for continuous real time capability for portfolios, the system for continuous real time portfolios and an interface, the system for continuous real time portfolios and an interface and World Wide Web for distribution of results, the system for continuous real time portfolios and World Wide Web for distribution of results.

It is expressly contemplated that the components and/or elements described herein can be implemented as an apparatus that comprises at least one network interface that communicates with a communication network, a processor coupled to the at least one network interface, and a memory configured to store program instructions executable by the processor. Further, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, the scope of the disclosed system should be determined not by the embodiment(s) described, but by the appended claims and their legal equivalents.

1. A method of securities trading, the method comprising:
receiving a plurality of data inputs from a plurality of information sources regarding one or more investment portfolios;
receiving a proposed change to at least one of the investment portfolios;
determining whether the proposed change would cause a deviation from one or more guidelines; and
when the proposed change causes a deviation from the one or more guidelines, rejecting the proposed change;
otherwise, transmitting one or more instructions for executing the proposed change.

2. The method of claim 1, wherein the plurality of data inputs are received in real time.

3. The method of claim 1, wherein the plurality of data inputs are received periodically.

4. The method of claim 1, wherein the one or more guidelines are unrelated to performance benchmarks.

5. The method of claim 4, wherein the one or more guidelines include one or more selected from the group consisting of: a list of restricted securities and limits on holdings of a particular security or type of security within a portfolio.

6. The method of claim 5, wherein the proposed change relates to a personal account of an individual and the list of restricted securities is set by the individual's employer.

7. A computer adapted and configured to perform the method of claim 1.

8. A non-transitory computer readable medium containing program instructions executable by a processor, the computer readable medium comprising:
program instructions that receive a plurality of data inputs from a plurality of information sources regarding one or more investment portfolios;
program instructions that receive a proposed change to at least one of the investment portfolios;
program instructions that determine whether the proposed change would cause a deviation from one or more guidelines; and
program instructions that, when the proposed change causes a deviation from the one or more guidelines, reject the proposed change;
program instructions that, otherwise, transmit one or more instructions for executing the proposed change.

9. A method of securities trading, the method comprising:
receiving instructions to execute a trade;
storing the instructions;
relaying the instructions for execution;
receiving an instruction to reverse the trade; and
generating and transmitting one or more additional instructions for execution, thereby reversing the trade.

10. The method of claim 9, wherein the instruction to reverse the trade is generated automatically upon detection that the trade violates one or more portfolio guidelines.

11. The method of claim 9, wherein the one or more additional instructions include cancelling or partially cancelling a pending trade.

12. The method of claim 9, wherein the one or more additional instructions include executing one or more new trades that have the effect of reversing the trade.

13. A computer adapted and configured to perform the method of claim 9.

14. A non-transitory computer readable medium containing program instructions executable by a processor, the computer readable medium comprising:
program instructions that receives instructions to execute a trade;
program instructions that store the instructions;
program instructions that relay the instructions for execution;
program instructions that receive an instruction to reverse the trade; and
program instructions that generate and transmit one or more additional instructions for execution, thereby reversing the trade.
